(19) United States
(12) Patent Application Publication
(10) Pub. No.: US 2012/0219163 A1
(43) Pub. Date: Aug. 30, 2012

(54) APPARATUS FACILITATING EFFECTIVE COMMUNICATION IN NOISE-PRONE ENVIRONMENTS

(75) Inventors: Vinod V. Mankar, Mumbai (IN); Mitesh Vasa, Bangalore (IN)

(73) Assignee: INTERNATIONAL BUSINESS MACHINES CORPORATION, Armonk, NY (US)

(21) Appl. No.: 13/034,909

(22) Filed: Feb. 25, 2011

(51) Int. Cl. H04B 15/00

(52) U.S. Cl. 381/94.1

(57) ABSTRACT

Methods and arrangements for providing soundproof audio communication from a mask assembly. A mask assembly includes a soundproof mask, the soundproof mask being adapted to cover a human nose and mouth. A microphone disposed in a portion of the mask and a venting arrangement provides fluid communication from an interior of the mask to an exterior of the mask. A communication connection which provides audio communication between the microphone and a processor.

### BACKGROUND

Phone conversations normally involve the presence of background noise which can disrupt a conversation or present difficulties for clear communication overall. Such background noise is particularly evident in call centers and other noisy environments involving customer service, where the noise can negatively impact the quality of service delivered to customers.

To reduce the effect of noise in calls made through call or contact centers and similar environments, noise-canceling microphones can be employed, but their effectiveness will be limited if the source of noise happens to be a colleague occupying a nearby desk (e.g., who may be talking animatedly with someone else), or another noise in a close vicinity. Moreover, the party on the other end of the call can still hear ambient noise coming from immediate surroundings of a noise-canceling microphone.

In typical office environments, it is also difficult to hold confidential discussions openly from one's desk (over the phone or in audio-based computer communication) in the fear of being overheard by people nearby, while it is often difficult to find an empty meeting room in which to hold discussions. This situation is exacerbated in those smaller companies which cannot afford to provide an adequate number of private meeting rooms, and even in larger companies that are taking on growing numbers of workers who are putting a strain on existing facilities. Solutions such as placing every employee in a soundproof room or enclosure are simply cost-prohibitive, especially on a larger scale such as in an office environment or call center.

### BRIEF SUMMARY

In summary, one aspect of the invention provides an apparatus comprising: a mask assembly comprising a soundproof mask; the soundproof mask being adapted to cover a human nose and mouth; a microphone disposed in a portion of the mask; a venting arrangement providing fluid communication from an interior of the mask to an exterior of the mask; and a communication connection which provides audio communication between the mask assembly and a processor.

Another aspect of the invention provides an apparatus comprising: a mask assembly comprising a soundproof mask; the soundproof mask being adapted to cover a human nose and mouth; a microphone disposed in a portion of the mask; a venting arrangement providing fluid communication from an interior of the mask to an exterior of the mask; at least one processor; and a communication connection which provides audio communication between the mask assembly and the at least one processor.

An additional aspect of the invention provides a method comprising: providing a mask assembly, the mask assembly including a soundproof mask adapted to cover a human nose and mouth, a microphone disposed in a portion of the mask and a venting arrangement providing fluid communication from an interior of the mask to an exterior of the mask; and outputting audio output from the microphone.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a computer system.

FIG. 2 schematically illustrates an open office environment.

FIG. 3 schematically illustrates a headset and mask connected with a processor.

FIG. 4 schematically illustrates components of a soundproof mask.

FIG. 5 schematically illustrates components of a headset.

FIG. 6 schematically illustrates components of a variant embodiment of a soundproof mask.

FIG. 7 sets forth a process more generally for providing soundproof audio communication from a mask assembly.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

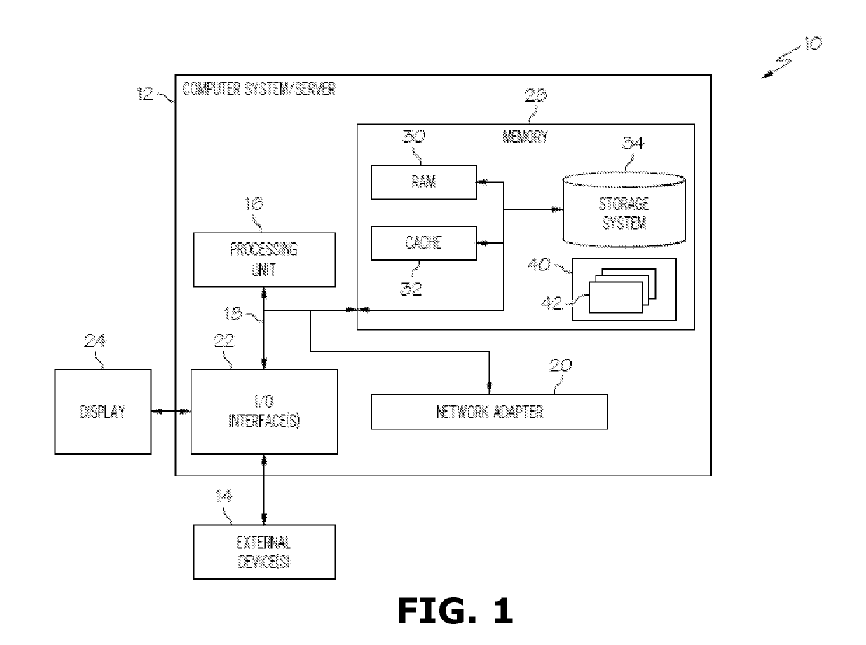

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In accordance with embodiments of the invention, computing node 10 may not necessarily even be part of a cloud network but instead could be part of another type of distributed or other network, or could represent a stand-alone node. For the purposes of discussion and illustration, however, node 10 is variously referred to herein as a “cloud computing node”.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via I/O interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

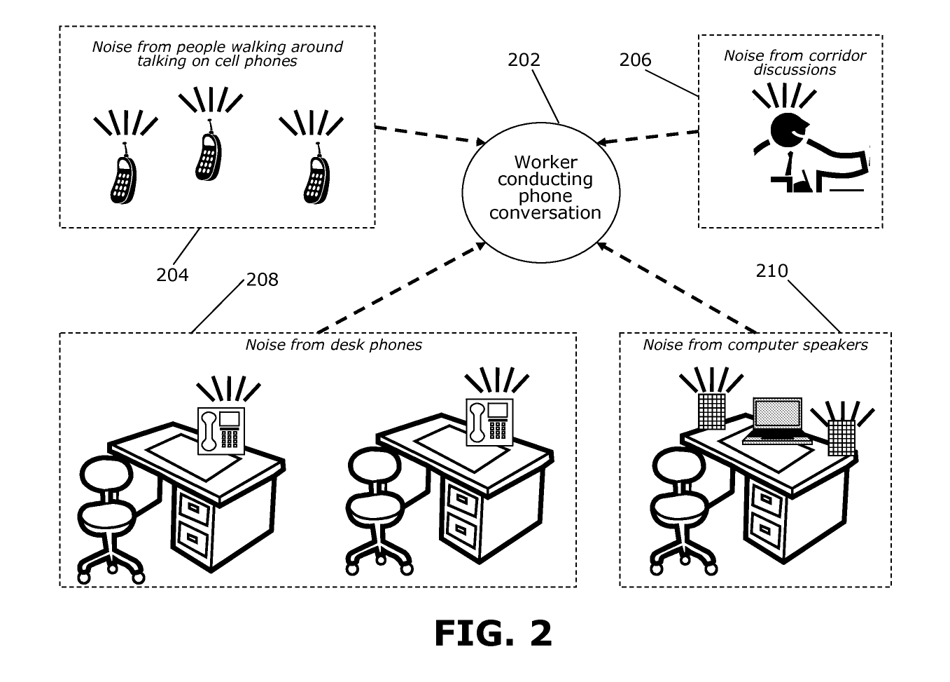

The disclosure now turns to FIGS. 2-6. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12 in FIG. 1. In accordance with an example embodiment, most if not all of the process steps, components and outputs discussed with respect to FIGS. 2-6 can be performed or utilized by way of a processing unit or units and system memory such as those indicated, respectively, at 16 and 28 in FIG. 1, whether on a server computer, a client computer, a node computer in a distributed network, or any combination thereof.

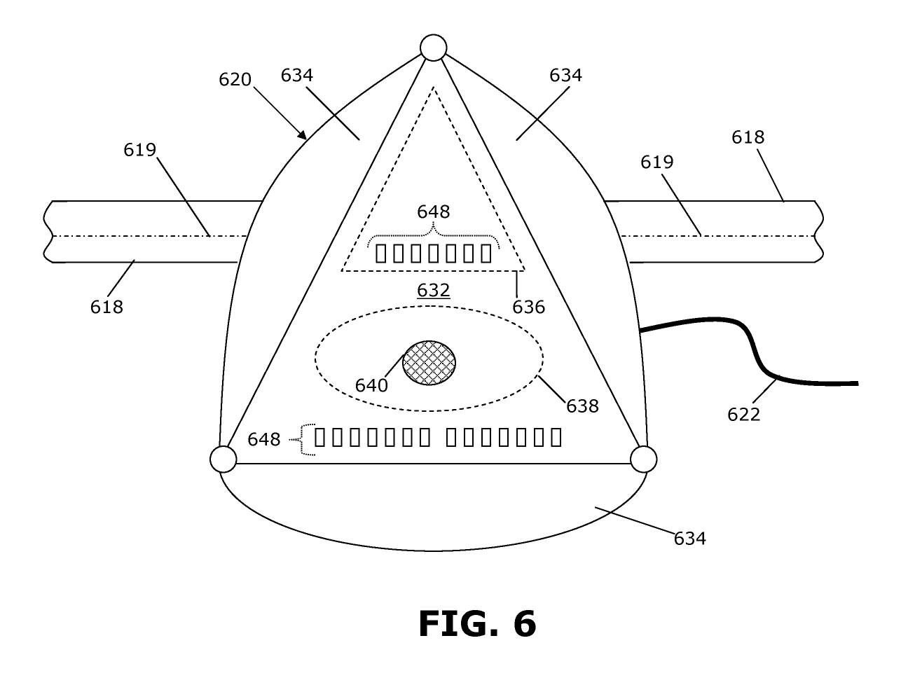

To facilitate easier reference, in advancing from FIG. 2 to and through FIG. 6, a reference numeral is advanced by a multiple of 100 in indicating a substantially similar or analogous component or element with respect to one or more components or elements found in one or more earlier figures among FIGS. 2-6.

In accordance with at least one embodiment of the invention, there is broadly contemplated herein a soundproof mask that covers the mouth and nose of an individual using a telephone and is attached to headphones being employed in the process. Such an apparatus may then connect to a desk phone, mobile phone or a computer for voice data calls.

FIG. 2 schematically illustrates an open office environment. As shown, a worker conducting a phone conversation 202 may often need to contend with noise distractions such as noise from people walking around talking on cell phones (204), noise from corridor discussions (206), noise from desk phones (208), such as ringing phones and desk phone conversations, and noise from computer speakers (210). These represent but examples of the acoustic distractions that can disrupt or compromise the quality of a phone conversation that the worker 202 is conducting. As mentioned previously, solutions that permit a clear and non-disrupted conversation have eluded conventional approaches, short of hypothetically isolating every single worker in a separate, and almost certainly cost-prohibitive, soundproof room or booth.

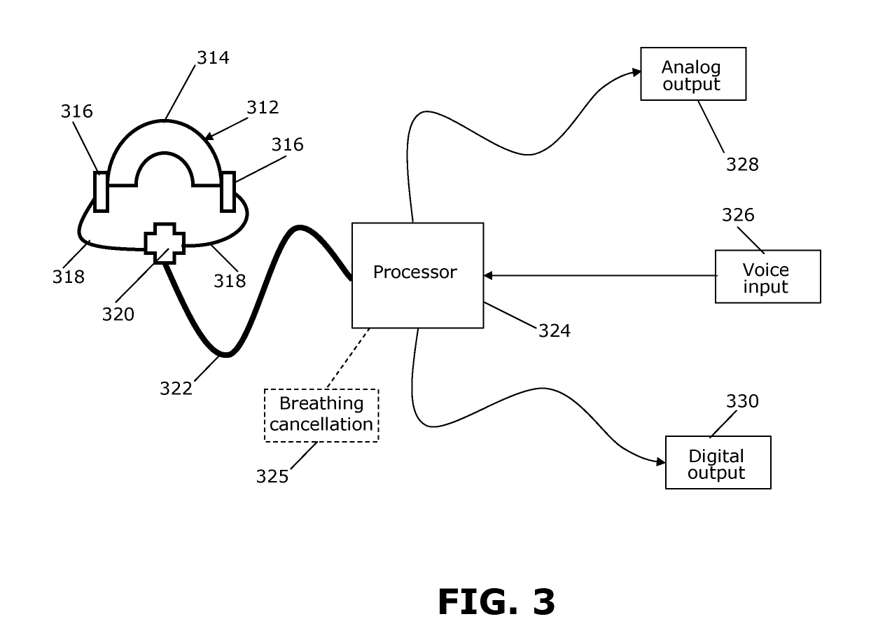

FIG. 3 schematically illustrates, in accordance with at least one embodiment of the invention, a headset and mask unit 312 connected with a processor 324. As shown, unit 312 includes a headset with headband 314 and left and right ear speakers 316. The headset ensemble 314/316 is connected with a mask 320 via flexible straps 318. The straps 318 make take different forms, as will be appreciated further from the discussion herebelow. Speakers 316 may include noise-canceling characteristics as employed in the telecommunication arts. Mask 320, intended to cover the nose and mouth of a user, is a soundproof mask with an incorporated microphone and has a provision for breathing/venting as will be appreciated herebelow. Mask 320 and its microphone are in communication with processor 324 via a wired connection or, alternatively, via a suitable wireless connection.

In accordance with at least one embodiment of the invention, processor 324 is in communication with a phone unit (such as a desktop phone unit) and, as such, accepts incoming voice input 326, such as voice input from another individual in a phone conversation. Processor 324 acts to accept the voice input 326 and, in view of the different possible types of voice input (e.g., from a landline, cell phone or computer connection), processes the same into a consistent or uniform format and then transmits this to mask 320 via connection 322 (or via another, analogously functioning communications link). Such formatted voice input is then communicated via wires in straps 318 to headset speakers 316.

When the user with headset 312 then speaks via the microphone in mask 320, such output is directed to processor 324 over connection 322, then processed as analog (328) or digital (330) output returned to the other individual via the communications link in play. Analog 328 output can include output suitable for transmission to a cell phone or landline phone, while digital output 330 can include output suitable for transmission to a computer. In accordance with at least one embodiment of the invention, processor 324 includes a module or provision for attending to breathing noise cancellation (325), such that the noise from the breathing patterns of the user with the headset 312, to the extent transmitted from the microphone in mask 320 to the processor 324, are canceled and thereby removed from the output sound pattern as part of its processing before being forwarded as analog and/or digital output (328/330). Breathing noise cancellation is known in that, with breathing as a rhythmic activity, its frequencies can be modeled and eliminated as noise at a processor such as the processor 324. For background purposes, illustrative and non-restrictive examples of models for breathing noise cancellation can be found in: B. Woodward and H. Sari, “Breathing noise elimination in through-water speech communication between divers,” Journal of the Acoustical Society of America, Vol. 121, Iss. 4, pp. EL156-EL160, April 2007; and Zheng Han et al., “Time-shared channel identification for adaptive noise cancellation in breath sound extraction,” Journal of Control Theory and Applications, Vol. 2, No. 3, pp. 209-221, 2004.

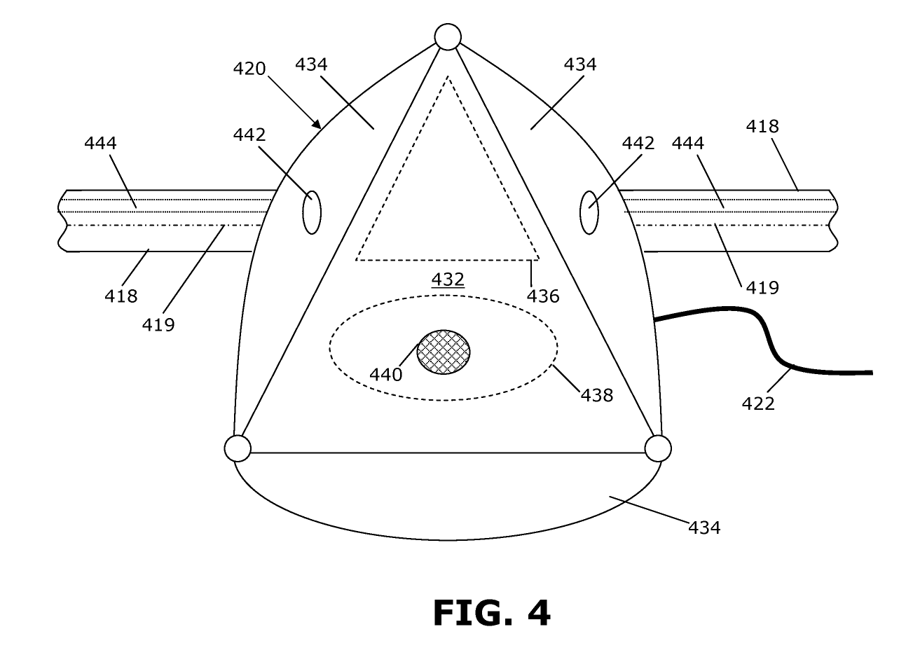

FIG. 4 schematically illustrates, in accordance with at least one embodiment of the invention, components of a soundproof mask 420. As but one non-restrictive example of a mask design (shown roughly and schematically), a central generally triangular or triangular-prismatic portion 432 may have flexible flaps 434 extending from each of the three sides thereof to facilitate fitting the mask 420 about a user's nose and mouth. As such, a nose portion or recess 436 is configured to accommodate a user's nose, while a recessed, e.g., frustoconical, portion 438 accommodates a microphone 440 that is conveniently positioned to readily accommodate a user's speaking while the mask 420 is worn. Microphone 440 is in communication with a connection 422 that leads to a processor (such as that indicated at 324 in FIG. 3); alternatively, a wireless connection with a processor may be employed.

In accordance with at least one embodiment of the invention, a flexible strap 418 extends from each of left and right flaps 434 to communicate and connect with a headset (such as that indicated at 314/316 in FIG. 3). Straps 418 may assist in holding the mask 420 onto a user's face in an airtight formation, while one or more additional elastic and/or flexible straps (not shown) could also connect with mask 420 and, e.g., serve to circumscribe a user's head to help hold the mask 420 in position on the user's face. Each strap 418 includes an internal wire 419 for transmitting an audio signal that has originated at a processor (such as that indicated at 324 in FIG. 3). Such an audio signal, e.g., can include a voice transmission from an individual with which the user wearing mask 420 is having a phone conversation. Wires 419 are suitably connected with connection 422 to permit such audio transmissions. The audio signal is transmitted through wires 419 to speakers of a headset, such as speakers 316 as shown in FIG. 3.

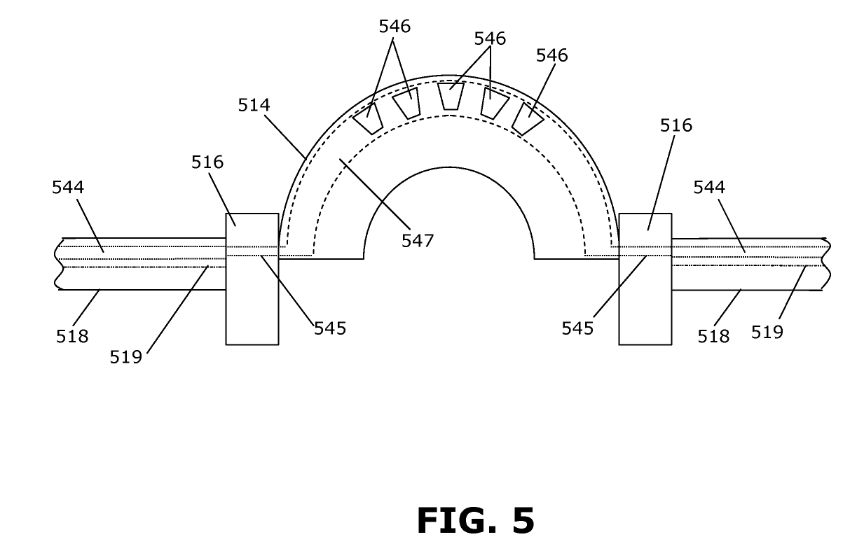

In accordance with at least one embodiment of the invention, straps 418 each also include air passages 444. As shown, an opening 442 in each of the flaps 434 provides communication with each respective air passage 444. The air passages 444 can be provided, for example, by tubes of hard but flexible plastic that permit straps 418 to remain flexible yet still allow air to progress unimpeded and bi-directionally through the passages 444 (e.g., by resisting kinking that might cut off the passage of air). Passages 444 can communicate with vent holes, such as in a headband, as will be appreciated more fully herebelow with respect to FIG. 5.

In accordance with at least one embodiment of the invention, the main body of mask 420, including portion 432 and the flap portions 434, is formed from a soundproof or sound-absorbing material such as acoustic foam. Similar material may be employed in the formation of straps 418, or at least in insulating about the air passages 444.

FIG. 5 schematically illustrates, in accordance with at least one embodiment of the invention, components of a headset. As shown, a headband 514 interconnects two ear speakers 516 and is configured for disposal about a portion of a user's head. Extending from each speaker 516 is a strap 518, which may be similar to or coincident with a strap 418 such as that shown in FIG. 4.

In accordance with at least one embodiment of the invention, within each strap 518, a wire 519 carries an audio signal similar to that described above with respect to wires 419 in FIG. 4. The audio signal in each wire 519 is respectively fed to the speakers 516. An air passage 544 is also disposed within each strap 518 to be in fluid communication with a mask such as that indicated at 420 in FIG. 4. Each air passage may be similar to or coincident with an air passage 444 such as one of those shown in FIG. 4. (The term “fluid communication”, as employed herein, can be understood to encompass, among other things, air-based or breathing communication, such that air may be conveyed to facilitate breathing)

In accordance with at least one embodiment of the invention, an internal air passage 545 in each speaker 516 is in fluid communication with a respective passage 544. In turn, headband 514 includes several breathing or vent holes 546, which vent to ambient, and themselves are in fluid communication with an internal air passage 547 in headband 514. The passage 547 is in fluid communication with passages 545; accordingly, this places the vent holes 546 in fluid communication with passages 544 of straps 518 and thereby with a mask such as that indicated at 420 in FIG. 4. This permits a user wearing a soundproof mask, such as that indicated at 420 in FIG. 4, to breathe adequately while talking into the soundproof mask.

In accordance with at least one embodiment of the invention, straps 518 are formed from a soundproof or sound-absorbing material such as acoustic foam. Alternatively, such material may be employed to insulate about the air passages 544. Such material may also be used to insulate about air passages 545 and 547 and to surround each individual vent hole 546 at its interface with ambient.

FIG. 6 schematically illustrates, in accordance with at least one variant embodiment of the invention, components of a soundproof mask 620. Mask 620 is similar in function and makeup to that indicated at 420 in FIG. 4, except for the provisions for breathing/venting. As shown, straps 628 do not include air passages such as those indicated at 444 in FIG. 4. Instead, several vent holes 648 are provided directly in the mask 620; though they can suitably be located anywhere in mask 620, here there is shown one set disposed within nose portion 636 and another at a lower portion of triangular portion 632 and below the vicinity of microphone 640. Such vent holes 648 thus accord a capability to breath directly to ambient from within the mask 620.

In accordance with at least one embodiment of the invention a soundproof or sound-absorbing material is employed to surround each individual vent hole 648 at its interface with ambient.

In view of the foregoing, it can be appreciated that by way of a significant advantage of a soundproof mask, in accordance with at least one embodiment of the invention, can obviate and overcome disadvantages such as those encountered with conventional noise-canceling microphones. Particularly, conventional noise-canceling microphones typically include one directional port pointing in the direction of a sound source and one more port which is pointed away. The latter port captures ambient noise, which is then subtracted from the source signal. Since, in accordance with at least one embodiment of the invention, an entire microphone is enclosed in a soundproof mask, noise is virtually eliminated at the outset and there is thus no need for duplicate microphones or for any extra circuitry that would be associated therewith.

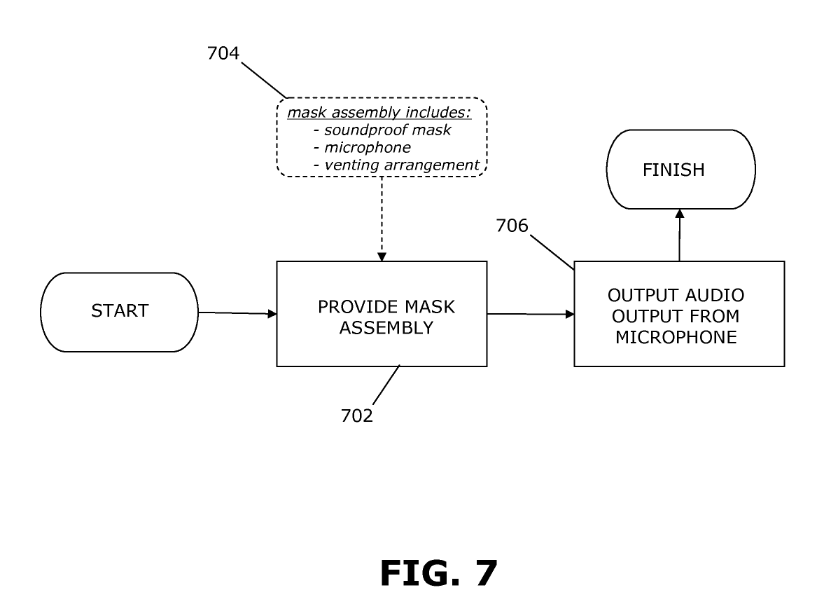

FIG. 7 sets forth a process more generally for providing soundproof audio communication from a mask assembly. It should be appreciated that a process such as that broadly illustrated in FIG. 7 can employ essentially any suitable computer system or set of computer systems, which may, by way of an illustrative and on-restrictive example, include a system such as that indicated at 12 in FIG. 1. In accordance with an example embodiment, much of the process discussed with respect to FIG. 7 can be performed by way a processing unit or units and system memory such as those indicated, respectively, at 16 and 28 in FIG. 1.

As shown in FIG. 7, a mask assembly is provided (702), with the mask assembly including (704) a soundproof mask adapted to cover a human nose and mouth, a microphone disposed in a portion of the mask and a venting arrangement providing fluid communication from an interior of the mask to an exterior of the mask. Audio output is output from the microphone (706).

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of one or more programming languages, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

What is claimed is:

1. An apparatus comprising:
a mask assembly comprising a soundproof mask;
said soundproof mask being adapted to cover a human nose and mouth;
a microphone disposed in a portion of said mask;
a venting arrangement providing fluid communication from an interior of said mask to an exterior of said mask; and
a communication connection which provides audio communication between said microphone and a processor.

2. The apparatus according to claim 1, wherein said communication connection provides bi-directional audio communication between said mask assembly and a processor.

3. The apparatus according to claim 1, wherein said mask is formed from a soundproof material.

4. The apparatus according to claim 1, wherein said mask assembly further comprises:
a headset; and
a strap arrangement extending between said mask and said headset.

5. The apparatus according to claim 4, wherein:
said strap arrangement comprises at least one air passage; and
said venting arrangement comprises at least one hole in communication with said air passages of said strap arrangement.

6. The apparatus according to claim 5, wherein said headset comprises a venting medium, said venting medium being in fluid communication with said air passages of said strap arrangement.

7. The apparatus according to claim 6, wherein said venting medium provides venting to ambient.

8. The apparatus according to claim 6, wherein said venting medium comprises at least one hole disposed in said headset.

9. The apparatus according to claim 6, wherein:
said headset comprises two headphones and a headband extending between said headphones; and
said venting medium comprises at least one hole disposed in said headband.

10. The apparatus according to claim 4, wherein said strap arrangement comprises a wire arrangement providing audio communication between said communication connection and said headset.

11. The apparatus according to claim 10, wherein said headset comprises headphones with noise-canceling characteristics.

12. The apparatus according to claim 1, wherein said venting arrangement comprises at least one hole disposed in said mask, the at least one hole acting to vent directly to ambient.

13. The apparatus according to claim 1, wherein said communication connection comprises a hard-wired communication connection.

14. An apparatus comprising:
a mask assembly comprising a soundproof mask;
said soundproof mask being adapted to cover a human nose and mouth;
a microphone disposed in a portion of said mask;
a venting arrangement providing fluid communication from an interior of said mask to an exterior of said mask;
at least one processor; and
a communication connection which provides audio communication between said microphone and said at least one processor.

15. The apparatus according to claim 14, further comprising:
a computer readable storage medium having computer readable program code embodied therewith and executable by said at least one processor, the computer readable program code comprising:
computer readable program code configured to accept audio output from said microphone via said communication connection; and
computer readable program code configured to cancel a breathing pattern from said audio output.

16. The apparatus according to claim 15, wherein said computer readable program code is further configured to further transmit audio output with a canceled breathing pattern onward as at least one of analog output and digital output.

17. The apparatus according to claim 15, wherein said computer readable program code is configured to accept audio input and process the audio input into a predetermined uniform format.

18. The apparatus according to claim 17, wherein said computer readable program code is configured to transmit audio input, processed a predetermined uniform format, to said mask assembly via said communication connection.

19. The apparatus according to claim 14, wherein said mask is formed from a soundproof material.

20. The apparatus according to claim 14, wherein said mask assembly further comprises a headset.

21. The apparatus according to claim 14, wherein said communication connection comprises a hard-wired communication connection.

22. A method comprising:
providing a mask assembly, the mask assembly including a soundproof mask adapted to cover a human nose and mouth, a microphone disposed in a portion of the mask and a venting arrangement providing fluid communication from an interior of the mask to an exterior of the mask; and
outputting audio output from the microphone.

23. The method according to claim 22, further comprising:
accepting audio output from the microphone; and
canceling a breathing pattern from the audio output.

24. The method according to claim 23, further comprising transmitting audio output with a canceled breathing pattern onward as at least one of analog output and digital output.

25. The method according to claim 23, further comprising:
accepting audio input and processing the audio input into a predetermined uniform format; and
thereafter transmitting the audio input to the mask assembly.

26. The method according to claim 22, wherein said outputting comprises outputting the audio output via a hard-wired communication connection.
